(19) United States
(12) Patent Application Publication
(10) Pub. No.: US 2020/0233279 A1
(43) Pub. Date: Jul. 23, 2020

(54) DRIVE CIRCUIT AND DRIVE METHOD FOR DRIVING ELECTRODEPOSITION ELEMENT

(71) Applicant: MURAKAMI CORPORATION, Shizuoka (JP)

(72) Inventors: Kodai KIKUCHI, Setagaya-ku (JP); Kazunori MIYAKAWA, Setagaya-ku (JP); Takuo MOCHIZUKA, Shimada-shi (JP)

(73) Assignee: MURAKAMI CORPORATION, Shizuoka (JP)

(21) Appl. No.: 16/636,459

(22) PCT Filed: Aug. 10, 2018
(86) PCT No.: PCT/JP2018/030095

§ 371 Date: Feb. 4, 2020

(30) Foreign Application Priority Data
Aug. 10, 2017 (JP) 2017-155357

(51) Int. Cl. G02F 1/163

(52) U.S. Cl. CPC G02F 1/163; H04N 5/238

(57) ABSTRACT

In a waiting period in which a transmission state of an electrodeposition element is held to be a predetermined transmission state such as a full-transmission state, based on a frequency, a duty ratio, a first voltage and a second voltage set in advance, a transmittance holding pulse generating section generates a pattern of a transmittance holding pulse having a cycle corresponding to the frequency and continuously outputs the pattern of the transmittance holding pulse to the electrodeposition element. In a light reduction period in which the transmission state of the electrodeposition element is held to be a light-reduced state (transmittance is lowered), the deposition start voltage generating section applies a third voltage, which is a preset deposition start voltage, to the electrodeposition element. Consequently, metal ions are easily deposited, enabling increasing a speed of dispersion of the metal ions.

### TECHNICAL FIELD

The present invention relates to a drive circuit and a drive method for driving an electrodeposition element used in a light control device in, e.g., an image pickup device or a display device.

### BACKGROUND ART

Conventionally, various electrochromic materials that upon a voltage being applied thereto, cause a light absorption phenomenon using an electrochemical oxidation or reduction reaction have been known. From among these electrochromic materials, examples of organic materials include a viologen derivative that produces color by reduction and ferrocene that produces color by oxidation and examples of inorganic materials include WO₃ (tungsten oxide) that produces color by reduction. Also, an electrocrystallization phenomenon in which a material ionized in a solvent is deposited on an electrode for light control, what is called an electrodeposition method, has been known. Electrodeposition elements in which metal ions are dispersed in a solvent and an electrochemical reaction is made to occur by performing electric control using the electrodeposition method have been known.

This electrochemical reaction provides high contrast in color change and has advantages of, e.g., low power consumption, and is thus expected to be applied to light control devices (devices having a light control function) in image pickup devices, display devices, windows, microscopes, endoscopes, etc.

In particular, electrodeposition elements using metal ions such as silver ions have even spectral characteristics for a visible light range, and thus, enable a transmittance to be changed with the even spectral characteristics maintained (see, for example, Non-Patent Literature 1).

Where an electrodeposition element is used in an image pickup device, an amount of incident light entering an image pickup element can be changed. In other words, the amount of incident light can be changed without depending on an aperture of a lens by a diaphragm, enabling shooting involving neither change in depth of field nor small aperture blurring caused by diffraction. Therefore, electrodeposition elements are expected to be applied to electronic variable ND (neutral density) filters that reduce an amount of incident light alone without affecting coloration.

Also, for display devices using an electrodeposition element, various methods for driving the electrodeposition element have been proposed. For example, a method in which a light-reduced state of an electrodeposition element is controlled to be a proper state has been proposed (see, for example, Patent Literature 1). This method is a method in which a density of pixels is controlled by applying a pulse of a voltage that is not larger than a threshold value at which metal ions are deposited, detecting a current value at that time, applying a write pulse according to the current value and repeating these steps.

### CITATION LIST

### Patent Literature

Patent Literature 1: Japanese Patent No. 3951950

### Non-Patent Literature

Non-Patent Literature 1: Kazunori Miyakawa, Kodai Kikuchi, et al, “Prototypes of Metal Salt Deposition-Type Electrochromic Light Control Element”, ITE (The Institute of Image Information and Television Engineers) Winter Annual Convention, 15B-1, 2016

### SUMMARY OF INVENTION

### Technical Problem

As stated above, electrodeposition elements have advantages of, e.g., high contrast and low power consumption and are thus expected to be used in various light control devices such as image pickup devices and display devices in the future. However, electrodeposition elements are known as having a low light reduction speed because a speed of dispersive movement of metal ions in an electrolyte solution is low.

Since the speed of action of metal ions contributing to a deposition reaction is limited by this movement speed and is thus low, a response of the transmittance change is generally slow. In other words, an electrodeposition element requires time for a change, for example, from a full-transmission state (non-deposition state) to a light-reduced state.

In this way, electrodeposition elements have the problem of requiring time when changing into a light-reduced state in which a transmittance is lower than that in a predetermined transmission state because a speed of reaction in metal ions being deposited on an electrode is low.

Therefore, the present invention has been made in order to solve the aforementioned problem and an object of the present invention is to provide a drive circuit and a drive method for driving an electrodeposition element, the drive circuit and the drive method enabling increasing a speed of reaction when an ionized material starts deposition on an electrode from a predetermined transmission state such as a full-transmission state.

### Solution to Problem

In order to solve the above problem, the drive circuit according to claim 1 is applying a voltage for changing a transmission state of an electrodeposition element, wherein: the drive circuit is configured to, when the electrodeposition element is in a predetermined transmission state, provide energy to an ionized material included in the electrodeposition element to vibrate the ionized material, and when making the electrodeposition element change from the predetermined transmission state into a light-reduced state in which a transmittance is lower than that of the predetermined transmission state, apply a predetermined voltage exceeding a preset crystal nucleation voltage to the electrodeposition element; and the crystal nucleation voltage is a voltage at which a crystal nucleus of the ionized material is generated on an electrode included in the electrodeposition element.

Also, the drive circuit according to claim 2 is the drive circuit according to claim 1, wherein: the drive circuit includes a pulse generating section and a deposition start voltage generating section; the pulse generating section is configured to, when the electrodeposition element is in the predetermined transmission state, generate a pulse as a voltage for providing energy to the ionized material included in the electrodeposition element to vibrate the ionized material, and continuously apply the pulse to the electrodeposition element in a predetermined cycle; the deposition start voltage generating section is configured to, when making the electrodeposition element change from the predetermined transmission state to the light-reduced state in which the transmittance is lower than that of the predetermined transmission state, generate a predetermined deposition start voltage as a voltage for the ionized material to start deposition and apply the deposition start voltage to the electrodeposition element; the pulse is a voltage that, with reference to a preset crystal growth voltage at which the crystal nucleus of the ionized material generated on the electrode included in the electrodeposition element grows, changes so as to exceed or fall below the crystal growth voltage; and the deposition start voltage is a voltage exceeding the preset crystal nucleation voltage at which the crystal nucleus of the ionized material is generated on the electrode included in the electrodeposition element.

Also, the drive circuit according to claim 3 is the drive circuit according to claim 2, wherein: a predetermined voltage that is not larger than the crystal nucleation voltage but is not smaller than the crystal growth voltage is defined as a first voltage and a predetermined voltage that is smaller than the crystal growth voltage is defined as a second voltage; and the pulse generating section is configured to, based on a preset frequency, the first voltage, the second voltage and duty ratios of the first voltage and the second voltage, generate a pattern of the pulse having a cycle corresponding to the frequency and continuously apply the pattern of the pulse to the electrodeposition element.

Also, the drive circuit according to claim 4 is the drive circuit according to claim 3, wherein the pulse generating section is configured to, when continuously applying the pattern of the pulse including the second voltage, open or short-circuit a circuit that applies a voltage from the drive circuit to the electrodeposition element, instead of applying the second voltage, during a period in which the second voltage is applied.

Also, the drive circuit according to claim 5 is the drive circuit according to any one of claims 1 to 4, wherein the predetermined transmission state is a full-transmission state.

Also, the drive circuit according to claim 6 is the drive circuit according to claim 3 or 4, wherein: the pulse generating section is configured to, when the electrodeposition element is in the full-transmission state, generate the pattern of the pulse as a pattern of a pulse for full transmission and continuously apply the pattern of the pulse for full transmission to the electrodeposition element; the deposition start voltage generating section is configured to, when making the electrodeposition element change from the full-transmission state to the light-reduced state, apply the deposition start voltage to the electrodeposition element; the pulse generating section is configured to, when the electrodeposition element is in a transmission state corresponding to the light-reduced state resulting from change caused by the application of the deposition start voltage by the deposition start voltage generating section, generate a pattern of a pulse for transmission, the pattern being different from the pattern of the pulse for full transmission (for example, the pattern having average energy (energy obtained by smoothing energy pulses) that is higher than average energy for the pulse for full transmission), and continuously apply the pattern of the pulse for transmission to the electrodeposition element; the pattern of the pulse for full transmission is a pattern that brings the electrodeposition element into the full-transmission state; and the pattern of the pulse for transmission is a pattern that causes the electrodeposition element to be held in a transmission state in which the transmittance is lower than that of the full-transmission state.

Also, the drive circuit according to claim 7 is the drive circuit according to claim 3 or 4, wherein: the drive circuit further includes a transmission returning voltage generating section; the transmission returning voltage generating section is configured to, when making the electrodeposition element change from the light-reduced state to a full-transmission state, generate a preset transmission returning voltage that causes the crystal nucleus of the ionized material to be dissolved and apply the transmission returning voltage to the electrodeposition element; the pulse generating section is configured to, when the electrodeposition element is in the full-transmission state, generate the pattern of the pulse as a pattern of a pulse for full transmission and continuously apply the pattern of the pulse for full transmission to the electrodeposition element; the deposition start voltage generating section is configured to, when making the electrodeposition element change from the full-transmission state to the light-reduced state, apply the deposition start voltage to the electrodeposition element; the transmission returning voltage generating section is configured to, when the electrodeposition element is in the light-reduced state resulting from change caused by the application of the deposition start voltage by the deposition start voltage generating section, apply the transmission returning voltage to the electrodeposition element; the pulse generating section is configured to, when the electrodeposition element is in a transmission state during a course of change into the full-transmission state due to the application of the transmission returning voltage by the transmission returning voltage generating section, generate a pattern of a pulse for transmission, the pattern being different from the pattern of the pulse for full transmission (for example, the pattern having average energy that is higher than average energy for the pulse for full transmission), and continuously apply the pattern of the pulse for transmission to the electrodeposition element; the pattern of the pulse for full transmission is a pattern that brings the electrodeposition element into the full-transmission state; and the pattern of the pulse for transmission is a pattern that causes the electrodeposition element to be held in the transmission state during the course.

### Advantageous Effect of Invention

As stated above, the present invention enables increasing a speed of reaction when an ionized material starts deposition on an electrode in a predetermined transmission state such as a full-transmission state. Then, the time of change from the predetermined transmission state to a light-reduced state with a transmittance that is lower than that of the predetermined transmission state can be shortened.

### BRIEF DESCRIPTION OF DRAWINGS

FIG. 1 is a schematic diagram illustrating an example configuration of a drive circuit and an electrodeposition element according to an embodiment of the present invention.

FIG. 2 is a diagram illustrating an example of a voltage applied to the electrodeposition element.

FIG. 3 is a diagram illustrating an example of a voltage applied to the electrodeposition element and a transmittance of the electrodeposition element.

FIG. 4 is a block diagram illustrating an example functional configuration of the drive circuit.

FIG. 5 is a diagram illustrating results of measurement of drive time.

FIG. 6 is a schematic diagram illustrating an example overall configuration of an image pickup device according to Example 1.

FIG. 7 is a block diagram illustrating an example configuration of a filter drive circuit.

FIG. 8 is a schematic diagram illustrating an example overall configuration of an image pickup device according to Example 2.

### DESCRIPTION OF EMBODIMENT

An embodiment of the present invention will be described below with reference to the drawings. The present invention is characterized by when an electrodeposition element is in a predetermined transmission state, providing dispersion energy (energy for dispersing an ionized material) to an ionized material in an electrolyte solution inside a light control layer to vibrate the ionized material and when making the electrodeposition element change from the predetermined transmission state to a light-reduced state, applying a voltage exceeding a crystal nucleation voltage.

Consequently, when making the electrodeposition element change into a light-reduced state, the ionized material is easily deposited on an electrode. In other words, a speed of reaction when an ionized material starts deposition on the electrode is increased, enabling increasing a light reduction speed and thus enabling shortening the time of change from a predetermined transmission state to a light-reduced state in which a transmittance is lower.

The below description will be provided taking a method of applying a voltage as an example of a method in which dispersion energy is provided to an ionized material inside a light control layer of an electrodeposition element to vibrate the ionized material.

### [Drive Circuit and Electrodeposition Elements]

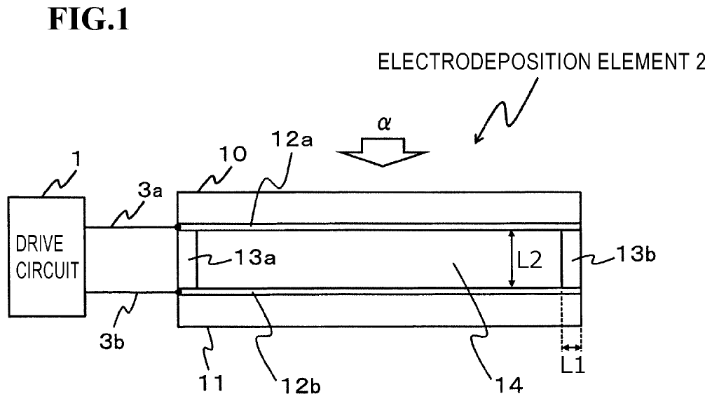

FIG. 1 is a schematic diagram illustrating an example configuration of a drive circuit and an electrodeposition element according to an embodiment of the present invention. A drive circuit 1 provides dispersion energy to metal ions in an electrodeposition element 2 and generates a voltage for controlling a transmission state of a light control layer 14 in order to change the transmission state to a desired light-reduced state. Then, the drive circuit 1 applies the voltage to the electrodeposition element 2 via conductive wires 3a, 3b. Round marks on the electrodeposition element 2 denote parts of connection between the conductive wires 3a, 3b and the electrodeposition element 2.

### (Electrodeposition Element 2)

The electrodeposition element 2 includes a transparent substrate 10, a substrate 11, transparent conductive films 12a, 12b, sealing materials 13a, 13b and the light control layer 14. The electrodeposition element 2 is configured by stacking the transparent substrate 10, the transparent conductive film 12a adjacent to the transparent substrate 10, the light control layer 14 and the sealing materials 13a, 13b adjacent to the transparent conductive film 12a, the transparent conductive film 12b adjacent to the light control layer 14 and the sealing materials 13a, 13b and the substrate 11 adjacent to the transparent conductive film 12b.

The transparent conductive film 12a is formed on the transparent substrate 10 and the transparent conductive film 12b is formed on the substrate 11 provided so as to face the transparent substrate 10. For example, where the electrodeposition element 2 is used in an image pickup device, the substrate 11 is a transparent substrate, and where the electrodeposition element 2 is used in a display device, the substrate 11 is a transparent substrate or a non-transparent substrate.

For the transparent substrate 10, for example, transparent glass is used, and for the substrate 11, for example, transparent glass or ceramic is used. For the transparent conductive films 12a, 12b, for example, ITO (indium tin oxide) is used.

The light control layer 14 is a layer formed of an electrolyte solution and is sandwiched between the transparent conductive film 12a formed on the transparent substrate 10 and the transparent conductive film 12b formed on the substrate 11 and between the sealing materials 13a, 13b.

For the electrolyte solution, for example, a liquid prepared by dissolving silver nitrate (AgNO₃), copper chloride (CuCl₂) and a lithium salt (Li) in PC (propylene carbonate), which is a non-aqueous solvent, and further adding a polymer for viscosity adjustment is used. For the sealing materials 13a, 13b, for example, an epoxy resin is used.

Where the electrodeposition element 2 is used in an image pickup device, incident light α enters from the outside of the transparent substrate 10 of the electrodeposition element 2. Then, the incident light α exits through the transparent substrate 10, the transparent conductive film 12a, the light control layer 14, the transparent conductive film 12b and the substrate 11 (in this case, a transparent substrate).

A size of a surface, as viewed from the incident light α side, of each of the transparent substrate 10 and the substrate 11 is approximately 5 cm□ and a resistance value of the transparent conductive film 12b is 8Ω/□. Peripheries of the transparent conductive films 12a, 12b are stuck to each other via the sealing materials 13a, 13b using an epoxy resin, with a width of approximately 2 mm (L1). A cell gap between the transparent conductive films 12a, 12b is approximately 300 μm (L2).

Note that for the transparent substrate 10, the substrate 11, the transparent conductive films 12a, 12b, the sealing materials 13a, 13b and the light control layer 14 included in the electrodeposition element 2, materials other than those mentioned above may be used. Also, spacers that support between the transparent substrate 10 with the transparent conductive film 12a and the substrate 11 with the transparent conductive film 12b may be provided at processing parts of the light control layer 14.

Also, each of the transparent conductive films 12a, 12b may be formed on the transparent substrate 10 or the substrate 11 in such a manner that the transparent conductive film 12a or 12b is divided in a plurality of areas, using a technique such as etching. Consequently, a voltage can be applied on an area-by-area basis, enabling area-based control.

Also, each of the transparent conductive films 12a, 12b may include figures such as asperities in a surface on the light control layer 14 side thereof. Consequently, the respective areas of the transparent conductive films 12a, 12b that are in contact with the light control layer 14 become larger, enabling an increase in area of an electrode on which metal ions are deposited. As a result, an amount of metal ions deposited increases, enabling a further increase in color reduction speed.

Here, the transmission state of the light control layer 14 is distinguished between a light-reduced state and a full-transmission state. The light-reduced state is a state in which metal ions are deposited on an electrode of either one of the transparent conductive films 12a, 12b, that is, a transmission state having a predetermined transmittance that is not the later described full-transmission state. The full-transmission state is a state in which a transmittance has been recovered by dissolution (detachment) of deposits of metal ions from the surface of the electrode.

### (Applied Voltage)

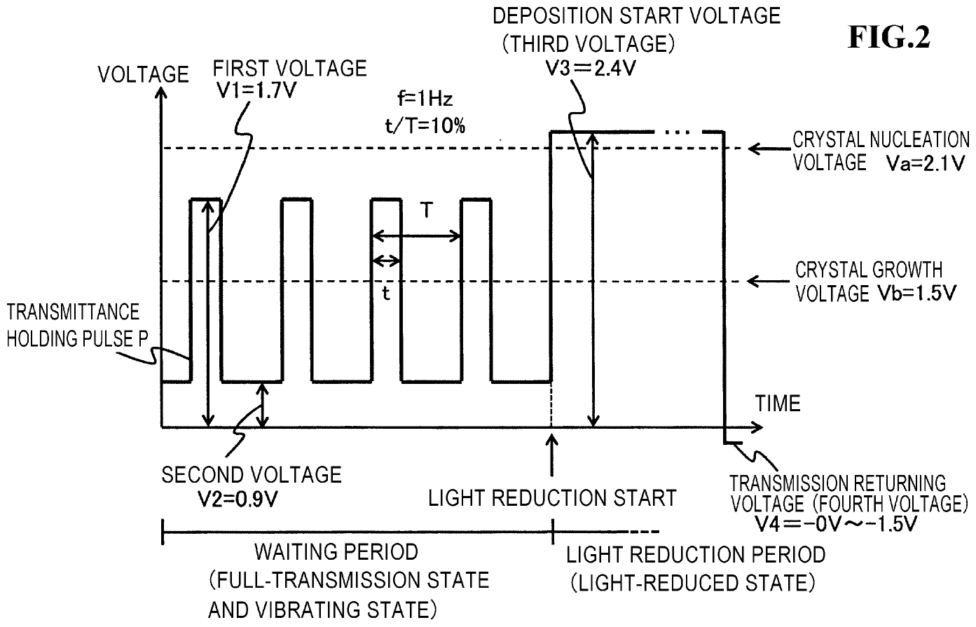

Next, the voltage applied from the drive circuit 1 to the electrodeposition element 2 will be described. FIG. 2 is a diagram illustrating an example of the voltage applied to the electrodeposition element 2. The ordinate axis represents a voltage applied to the electrodeposition element 2 with the electrode on which metal ions are deposited as a reference, and the abscissa axis represents time. Specific description will be provided with reference to FIGS. 1 and 2.

In a waiting period in which the transmission state of the electrodeposition element 2 is held to be the full-transmission state, the drive circuit 1 continuously applies a transmittance holding pulse P to the electrodeposition element 2 in a predetermined cycle.

This waiting period is a period in which the transmission state of the electrodeposition element 2 is held to be the full-transmission state. Also, the waiting period is a period in which dispersion energy is intermittently provided to the metal ions inside the light control layer 14 by continuously applying the transmittance holding pulse P in the predetermined cycle. Therefore, in this waiting period, the inside of the light control layer 14 is in a vibrating state in which dispersion energy remains in the metal ions and the metal ions thus vibrate. The vibration of the metal ions here is vibration synchronized with the transmittance holding pulses P. In other words, a frequency of vibration of the metal ions is equal to a frequency of the transmittance holding pulse P.

The transmittance holding pulse P is a pulse formed of a first voltage V1 that is not larger than a crystal nucleation voltage Va but is not smaller than a crystal growth voltage Vb and a second voltage V2 that is smaller than the crystal growth voltage Vb.

The crystal nucleation voltage Va is a voltage with which a deposition layer is generated by crystal nuclei of metal ions being formed on the electrode of either one of transparent conductive films 12a, 12b by application of the voltage Va. The crystal growth voltage Vb is a voltage with which already-generated crystal nuclei grow. In other words, although the crystal nucleation voltage Va is necessary to form crystal nuclei of metal ions on the electrode from a state in which no crystal nuclei are formed, once crystal nuclei are formed, the crystal nuclei can be made to grow even with the crystal growth voltage Vb that is lower than the crystal nucleation voltage Va.

The first voltage V1 is a voltage for providing dispersion energy to the metal ions inside the light control layer 14 to vibrate the metal ions. The second voltage V2 is a voltage for preventing growth of few crystal nuclei remaining on the electrode to avoid change in transmittance. In other words, if the first voltage V1 that is not smaller than the crystal growth voltage Vb is continuously applied to the electrodeposition element 2, the crystal nuclei grow and change the transmittance and the metal ions cannot be vibrated. On the other hand, instead of the first voltage V1 being continuously applied, the second voltage V2 that is smaller than the crystal growth voltage Vb is periodically applied in place of the first voltage V1, enabling prevention of growth of the crystal nuclei to avoid change in transmittance and enabling vibrating the metal ions.

In other words, the drive circuit 1 continuously applies the transmittance holding pulse P formed of the first voltage V1 and the second voltage V2 in a predetermined cycle, enabling providing dispersion energy to the metal ions with the first voltage V1 to vibrate the metal ions and enabling avoiding growth of the crystal nuclei remaining on the electrode with the second voltage V2. Also, since the transmittance does not change, the full-transmission state can be held. Here, the transmittance holding pulse P is a pulse whose pattern (for example, a later-described duty ratio t/T) varies depending on the transmittance to be held. In other words, the transmittance to be held can be changed according to the pattern of the pulse. Therefore, in the waiting state, it is possible to maintain a state in which dispersion energy is made to remain in the metal ions to vibrate the metal ions, while keeping the full-transmission state.

For example, the frequency f of the transmittance holding pulse P is 1 Hz and the duty ratio t/T of the transmittance holding pulse P is 10%. Here, t is a time length of the first voltage V1 and T is a cycle of the transmittance holding pulse P. The crystal nucleation voltage Va is 2.1V, the crystal growth voltage Vb is 1.5V, the first voltage V1 is 1.7V and the second voltage V2 is 0.9V.

At the time of a start of light reduction to change the transmission state of the electrodeposition element 2 from the full-transmission state to the light-reduced state, the drive circuit 1 applies a third voltage V3, which is a deposition start voltage exceeding the crystal nucleation voltage Va, to the electrodeposition element 2. In a light reduction period in which the transmission state of the electrodeposition element 2 is held to be the light-reduced state (the transmittance is lowered), the drive circuit 1 applies the third voltage V3 to the electrodeposition element 2. In the example in FIG. 2, the third voltage V3 is 2.4V.

Consequently, since the third voltage V3 is applied in a state in which dispersion energy remains in the metal ions and the metal ions are thus vibrating (that is, the metal ions are vibrating immediately before the start of application of the third voltage V3), the metal ions are easily deposited. As a result, the speed of reaction when metal ions start deposition on the electrode is increased, enabling an increase in light reduction speed.

The transmittance in the light-reduced state is determined according to the time of application of the third voltage V3. As the time of application of the third voltage V3 is longer, the transmittance becomes lower.

In order to return the transmission state of the electrodeposition element 2 from the light-reduced state to the full-transmission state, the drive circuit 1 applies a fourth voltage V4, which is a transmission returning voltage, to the electrodeposition element 2. In the example in FIG. 2, the fourth voltage V4 is −0V to −1.5V.

The fourth voltage V4, which is a transmission returning voltage, is a voltage for causing the grown crystal nuclei to be dissolved inside the light control layer 14. The transmission state of the electrodeposition element 2 can be made to return to the full-transmission state, by continuously applying the fourth voltage V4. At this time, since no transmittance holding pulse P is applied, no dispersion energy is provided and the metal ions thus enter a non-vibrating state in which the metal ions do not vibrate.

Here, during the course of the transmission state of the electrodeposition element 2 returning from the light-reduced state to the full-transmission state, if the drive circuit 1 continuously applies the transmittance holding pulse P in a predetermined cycle, the transmission state having a transmittance that of at the time of the start of the application of the transmittance holding pulse P (that is, immediately before the application of the transmittance holding pulse P) can be maintained.

Note that the first voltage V1 needs to be not larger than the crystal nucleation voltage Va (=2.1) but be not smaller than the crystal growth voltage Vb (=1.5) and in the above-described example, is 1.7V. However, the first voltage V1 varies depending on, e.g., the composition of the electrolyte solution and is preferably 1.5V to 2.0V.

Also, the second voltage V2 needs to be smaller than the crystal growth voltage Vb (=1.5V) and in the above-described example, is a voltage that is 0.9V, preferably no less than 0.5V but less than 1.5V. Upon application of a voltage of no more than 0.4V as the second voltage V2, a reverse bias is imposed on an electric field created by a slight amount of metal ions charged on the electrode. In this case, the dispersion energy provided to the metal ions is cancelled, and thus, no dispersion energy can be made to remain in the metal ions, resulting in failure to maintain a state in which the metal ions are vibrated. As a result, the speed of reaction when metal ions start deposition on the electrode cannot be increased. Therefore, it is desirable that the second voltage V2 be smaller than the crystal growth voltage Vb (=1.5V) but be not smaller than 0.5V at which no reverse bias is imposed on an electric field created by metal ions on the electrode.

When applying the second voltage V2 included in the transmittance holding pulse P, during the period of application of the second voltage V2, the drive circuit 1 may open a circuit connected to the conductive wires 3a, 3b or short-circuit between the conductive wires 3a, 3b, instead of applying the second voltage V2. Consequently, the state in which dispersion energy is provided to the metal ions and the metal ions are thus vibrating can be maintained as it is. In other words, the state in which the metal ions are vibrating can be maintained by alternately repeating a period in which the first voltage V1 is provided and a period in which no first voltage is provided (no voltage that is higher than the first voltage V1 is provided, too).

Also, the third voltage V3 is a voltage that needs to exceed the crystal nucleation voltage Va, and in the above-described example, is 2.4V and preferably, exceeds 2.1V but is no more than 3.0V. If the third voltage is higher than 3.0V, a response when the transmittance changes can potentially be made more quickly. Nevertheless, the third voltage is set to be no more than 3.0V because if the third voltage exceeds 3.0V, decomposition, uneven deposition or burn-in of the solvent may occur. However, even if the third voltage V3 is no more than 3.0V, the metal ions easily move because the metal ions were vibrating until just before the start of application of the third voltage V3, and thus, in comparison with the case where there was no such vibration, when application of the third voltage V3 is started, movement of the metal ions is facilitated, and thus, a response when the transmittance changes can be made more quickly.

Also, in the pattern of the transmittance holding pulse P applied continuously in the predetermined cycle, the frequency f thereof is 1 Hz in the above-described example and is preferably 1 Hz to 100 Hz.

Also, in the pattern of the transmittance holding pulse P continuously applied in the predetermined cycle, a duty ratio t/T is 10% in the above-described example and is preferably a value that is larger than 0 but smaller than 100%.

Also, although the waveform of the transmittance holding pulse P illustrated in FIG. 2 is rectangular, the waveform may be, e.g., triangular or sinusoidal. In brief, the pattern of the transmittance holding pulse P applied continuously in the predetermined cycle may be any pattern as long as such pattern enables maintaining a state in which dispersion energy remains in the metal ions and the metal ions thus vibrate.

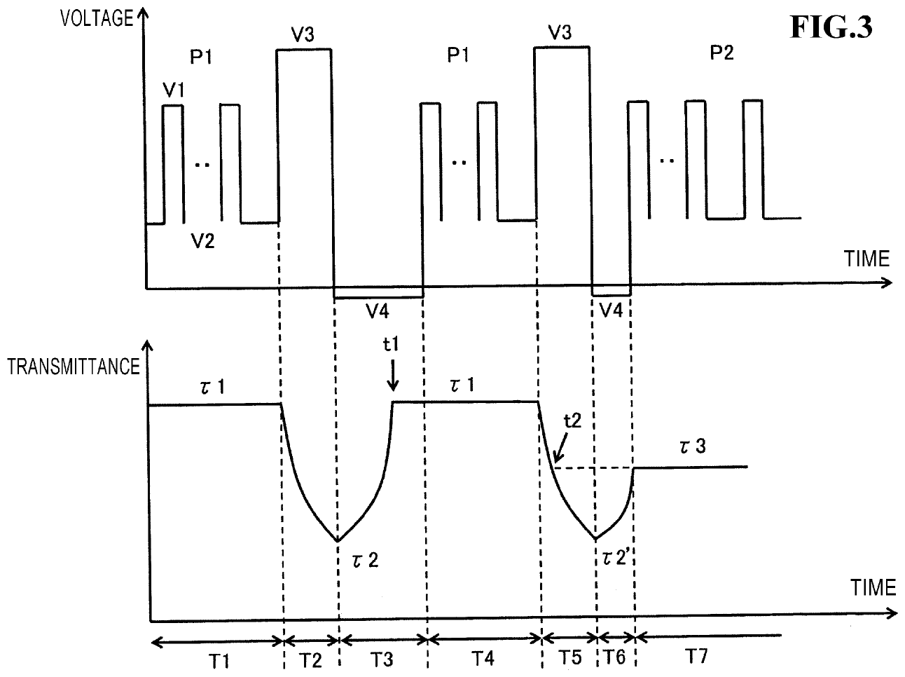

FIG. 3 is a diagram illustrating an example of the voltage applied to the electrodeposition element 2 and the transmittance of the electrodeposition element 2. In the upper graph in FIG. 3, the ordinate axis represents the voltage applied to the electrodeposition element 2 with the electrode on which metal ions are deposited as a reference, and the abscissa axis represents time. In the lower graph in FIG. 3, the ordinate axis represents the transmittance and the abscissa axis represents time.

In period T1, the drive circuit 1 continuously applies a pulse for full transmission (full-transmission pulse) P1 for holding the transmission state to be the full-transmission state to the electrodeposition element 2 in a predetermined cycle. The transmission state of the electrodeposition element 2 at this time is a full-transmission state with a transmittance τ1 and is a vibrating state in which dispersion energy remains in the metal ions and the metal ions thus vibrate.

In period T2, the drive circuit 1 applies the third voltage V3, which is a deposition start voltage, to the electrodeposition element 2. The transmission state of the electrodeposition element 2 at this time is a light-reduced state in which the transmittance τ1 is lowered to a transmittance τ2. The transmittance τ2 is determined according to the time of application of the third voltage V3, and as the time of application of the third voltage V3 is longer, the transmittance τ2 becomes lower.

In period T3, the drive circuit 1 applies the fourth voltage V4, which is a transmission returning voltage, to the electrodeposition element 2. The transmission state of the electrodeposition element 2 at this time is a light-reduced state in which the transmittance τ2 is raised to the transmittance τ1 in a period from a start of the period T3 to time point t1 and is the full-transmission state with the transmittance τ1 in a period from time point t1 to an end of period T3. The transmission state in period T3 is a non-vibrating state in which no dispersion energy remains in the metal ions and the metal ions do not vibrate.

In period T4, the drive circuit 1 continuously applies the full-transmission pulse P1 to the electrodeposition element 2 in the predetermined cycle. As in period T1, the transmission state of the electrodeposition element 2 at this time is the full-transmission state with the transmittance τ1 and is the vibrating state in which dispersion energy remains in the metal ions and the metal ions thus vibrate.

In period T5, the drive circuit 1 applies the third voltage V3, which is a deposition start voltage, to the electrodeposition element 2. As in period T2, the transmission state of the electrodeposition element 2 at this time is a light-reduced state in which the transmittance τ1 is lowered to a transmittance τ2′. As in the case of period T2, the transmittance τ2′ is determined according to the time of application of the third voltage V3, and as the time of application of the third voltage V3 is longer, the transmittance τ2′ becomes lower.

In period T6, the drive circuit 1 applies the fourth voltage V4, which is a transmission returning voltage, to the electrodeposition element 2. The transmission state of the electrodeposition element 2 at this time is a light-reduced state in which the transmittance τ2′ is raised to a transmittance τ3.

In period T7, when the transmission state of the electrodeposition element 2 is the state having the transmittance τ3 (<τ1) before reaching the full-transmission state with the transmittance τ1, the drive circuit 1 continuously applies a pulse for transmission (transmission pulse) P2 for holding the transmission state having the transmittance τ3 to the electrodeposition element 2 in a predetermined cycle. Consequently, the transmission state of the electrodeposition element 2 is a transmission state having the transmittance τ3 and a vibrating state in which dispersion energy remains in the metal ions and the metal ions thus vibrate occurs.

In other words, in period T7, the drive circuit 1 continuously applies the transmission pulse P2 in the predetermined cycle, thereby provides dispersion energy to the metal ions to vibrate the metal ions and enables to avoid growth of crystal nuclei remaining on the electrode. Also, since the transmittance τ3 does not change, the transmission state with the transmittance τ3, which is not the full-transmission state, can be held. Therefore, a state in which dispersion energy is made to remain in the metal ions and the metal ions are thus vibrated can be maintained while the transmission state with the transmittance τ3, which is not the full-transmission state, being held.

A pattern of the transmission pulse P2 continuously applied in the predetermined cycle is a pattern for holding the transmission state with the transmittance τ3, which is not the full-transmission state and thus is different from the pattern of the full-transmission pulse P1 for keeping the full-transmission state with the transmittance τ1. In other words, the pattern of the transmission pulse P2 and the pattern of the full-transmission pulse P1 are different from each other in waveform. For example, for a duty ratio t/T of the transmission pulse P2, a value that is different from that of the duty ratio t/T of the full-transmission pulse P1 is set in advance. As a specific example, a method of setting the pattern of the full-transmission pulse P1 and the pattern of the transmission pulse P2 based on tests will be described. The transmittance of the electrodeposition element 2 is measured while the transmittance holding pulse P being applied to the electrodeposition element 2. At this time, respective appropriate fixed values are set for the frequency f, the first voltage V1 and the second voltage V2 of the applied transmittance holding pulse P to adjust the duty ratio t/T. A duty ratio t/T at which the full-transmission state with transmittance τ1 is held is confirmed through the adjustment. As a result, a pattern specified by the frequency f, the first voltage V1 and the second voltage V2 set as the fixed values and the confirmed duty ratio t/T is set as the pattern of the full-transmission pulse P1. The pattern of the transmission pulse P2 can be set as a pattern obtained by increasing the duty ratio t/T to an arbitrary value relative to the set pattern of the full-transmission pulse P1. In other words, increasing the duty ratio t/T of the transmission pulse P2 to an arbitrary value relative to the duty ratio t/T of the full-transmission pulse P1 enables lowering the transmittance relative to the full-transmission state. Alternatively, fixing the value of the duty ratio t/T of the transmission pulse P2 to be the same as that of the duty ratio t/T of the full-transmission pulse P1 and increasing voltage values of the first voltage V1 and/or the second voltage V2 of the transmission pulse P2 to arbitrary values relative to the first voltage V1 and/or the second voltage V2 of the full-transmission pulse P1 also enables lowering the transmittance relative to the full-transmission state. Various data (parameter data such as the frequency f, the duty ratio t/T, the first voltage V1 and the second voltage V2) on the pattern of the full-transmission pulse P1 for holding the full-transmission state and the patterns of the transmission pulse P2 for holding transmission states (light-reduced states) with various transmittances, which have been obtained from the tests, can be stored in a memory in advance. Then, depending on the transmittance to be held, data of the corresponding pattern is read out and a pattern of the full-transmission pulse P1 or a pattern of the transmission pulse P2 is generated and applied to the electrodeposition element 2, enabling the electrodeposition element 2 to be held in the corresponding transmission state.

Note that in the example in FIG. 3, the drive circuit 1 is configured to, in the process of changing from the full-transmission state with the transmittance τ1 in period T4 to the light-reduced state that is the transmission state with the transmittance τ3 in period T7, apply the third voltage V3 in period T5, apply the fourth voltage V4 in period T6 and continuously apply the transmission pulse P2 in the predetermined cycle in period T7.

However, the drive circuit 1 may be configured so as to lower the transmittance to directly change the full-transmission state with the transmittance τ1 in period T4 to the light-reduced state that is the transmission state with the transmittance τ3. In this case, the drive circuit 1 applies the third voltage V3 at a start of period T5, and at time point t2 at which the transmittance is lowered to the transmittance τ3, continuously applies the transmission pulse P2 in the predetermined cycle.

### (Details of the Drive Circuit 1)

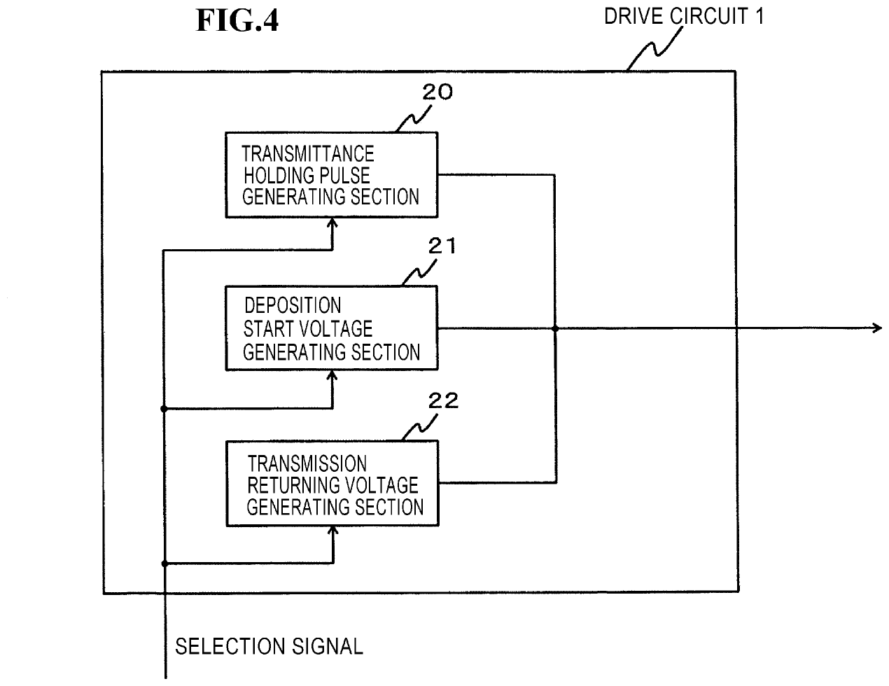

Next, the drive circuit 1 illustrated in FIG. 1 will be described in detail. FIG. 4 is a block diagram illustrating an example functional configuration of the drive circuit 1. The drive circuit 1 includes a transmittance holding pulse generating section 20, a deposition start voltage generating section 21 and a transmission returning voltage generating section 22.

The drive circuit 1 receives an input of a selection signal and selects any one of the transmittance holding pulse P, the third voltage, which is a deposition start voltage, and the fourth voltage, which is a transmission returning voltage, according to the selection signal and outputs the selected one. The selection signal indicates any of “transmittance holding” (holding of a predetermined transmission state such as the full-transmission state), “light reduction” and “transmission” (return to the full-transmission state).

The transmittance holding pulse generating section 20 receives the input of the selection signal, and if the selection signal indicates “transmittance holding”, based on the frequency f, the duty ratio t/T, the first voltage V1 and the second voltage V2 set in advance, generate a pattern of the transmittance holding pulse P having a cycle corresponding to the frequency f. Then, the transmittance holding pulse generating section 20 continuously outputs a voltage of the pattern of the transmittance holding pulse P to the electrodeposition element 2.

As described above, the first voltage V1 is a voltage that is not larger than the crystal nucleation voltage Va but is not smaller than the crystal growth voltage Vb, and the second voltage V2 is a voltage that is smaller than the crystal growth voltage Vb. The crystal nucleation voltage Va and the crystal growth voltage Vb are set in advance according to the electrolyte solution in the light control layer 14 of the electrodeposition element 2. The same applies to the third voltage V3, which is a deposition start voltage, and the fourth voltage V4, which is a transmission returning voltage, which will be described later.

More specifically, the transmittance holding pulse generating section 20 reads out a frequency f, a duty ratio t/T, a first voltage V1 and a second voltage V2 corresponding to the transmittance of the electrodeposition element 2 from the memory and generates the pattern of the transmittance holding pulse P based on these data. In the memory, for example, various data of a frequency f, etc., for the transmittance τ1 for the full-transmission state, various data of a frequency f, etc., for a predetermined range of transmittance including the transmittance τ2 and various data of a frequency f, etc., for a predetermined range of transmittance including the transmittance τ3 are stored.

For example, at the start of period T1 of the full-transmission state illustrated in FIG. 3, the transmittance holding pulse generating section 20 reads out various data of the frequency f, etc., for the transmittance τ1 from the memory and generates the pattern of the full-transmission pulse P1. Then, in period T1, the transmittance holding pulse generating section 20 continuously output a voltage of the pattern of the full-transmission pulse P1 to the electrodeposition element 2.

Also, at the start of period T7 of the transmission state illustrated in FIG. 3, the transmittance holding pulse generating section 20 reads out various data of the frequency f, etc., for the transmittance τ3 from the memory and generates the pattern of the transmission pulse P2. It can be known from, for example, a length of period T5 in which the third voltage V3 is applied and a length of period T6 in which the fourth voltage V4 is applied that the transmittance at the start of period T7 is T3. Alternatively, although the configuration becomes complex, it can be known by actually optically detecting the transmittance of the electrodeposition element 2. Then, in period T7, the transmittance holding pulse generating section 20 continuously outputs a voltage of the pattern of the transmission pulse P2 to the electrodeposition element 2.

The deposition start voltage generating section 21 receives the input of the selection signal, and if the selection signal indicates “light reduction”, generates the preset deposition start voltage, as the third voltage V3. Then, the deposition start voltage generating section 21 outputs the third voltage V3 to the electrodeposition element 2. As described above, the third voltage V3 is a voltage exceeding the crystal nucleation voltage Va.

The transmission returning voltage generating section 22 receives the input of the selection signal, and if the selection signal indicates “transmission”, generates the preset transmission returning voltage as the fourth voltage V4. Then, the transmission returning voltage generating section 22 outputs the fourth voltage V4 to the electrodeposition element 2. As described above, the fourth voltage V4, which is a transmission returning voltage, is a voltage for returning the transmission state of the electrodeposition element 2 from a light-reduced state to the full-transmission state.

Note that FIG. 4 illustrates a functional configuration functionally expressing an actual circuit in the drive circuit 1, and in reality, the drive circuit 1 includes two or more output terminals as output sections for output to the electrodeposition element 2. The drive circuit 1 applies potentials set in advance to the respective output terminals. Consequently, a potential difference corresponding to any of various voltages described above occurs between the output terminals.

As described above, with the drive circuit 1 according to the embodiment of the present invention, in a waiting period in which the transmission state of the electrodeposition element 2 is held to be a predetermined transmission state such as the full-transmission state, based on the frequency f, the duty ratio t/T, the first voltage V1 and the second voltage V2 set in advance, the transmittance holding pulse generating section 20 generates a pattern of a transmittance holding pulse P having a cycle corresponding to the frequency f and continuously outputs a voltage of the pattern of the transmittance holding pulse P to the electrodeposition element 2.

Consequently, metal ions inside the light control layer 14 can be vibrated by providing dispersion energy to the metal ions with no change in amount of incident light (without light reduction by decreasing the amount of incident light), and also, growth of crystal nuclei remaining on the electrode can be avoided. In other words, a state in which dispersion energy is made to remain on the metal ions and the metal ions are thus consistently vibrated can be maintained while the predetermined transmission state such as the full-transmission being held, enabling preventing fixation of the metal ions (state in which the metal ions less easily move).

Then, in a “light reduction” period in which the transmission state of the electrodeposition element 2 is held to be a light-reduced state (transmittance is lowered), the deposition start voltage generating section 21 applies the third voltage V3, which is a preset deposition start voltage, to the electrodeposition element 2.

Consequently, in a state in which dispersion energy remains in the metal ions and the metal ions thus are vibrating, the third voltage V3, which is a deposition start voltage, is applied, and thus, the metal ions are easily deposited, enabling increasing a speed of reaction when metal ions start deposition on the electrode. In other words, a speed of the light reduction can be increased, enabling shortening the time of change from the predetermined transmission state to the light-reduced state in which the transmittance is lower.

### [Test Results]

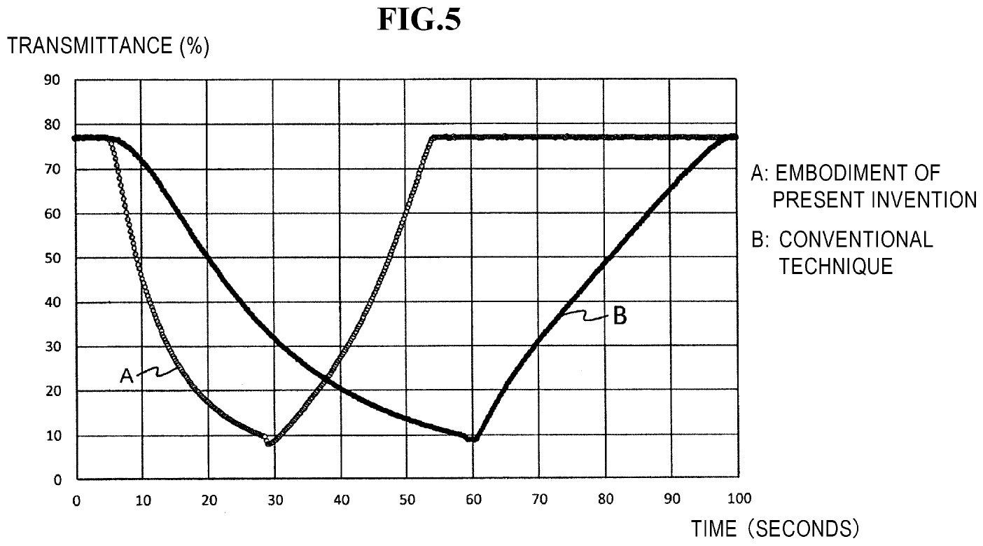

Next, test results will be described. FIG. 5 is a diagram illustrating results of measurement of time of driving of the electrodeposition element 2. The ordinate axis represents transmittance (%) and the abscissa axis represents time (seconds). Measurement result A of the embodiment of the present invention and measurement result B of a conventional technique indicate respective temporal changes in transmittance when light having a wavelength of 550 nm was made to enter a same electrodeposition element 2, and light reduction started at the time of five seconds.

Measurement result A of the embodiment of the present invention is a measurement result where a transmittance holding pulse P, a third voltage V3, which is a deposition start voltage, and a fourth voltage V4, which is a transmission returning voltage, were used. The drive circuit 1 applied the transmittance holding pulse P illustrated in FIG. 2 to the electrodeposition element 2 for five seconds and applied the third voltage V3=2.4V, which is a deposition start voltage, at the time of five seconds, which is the time of the start of light reduction. A measurement result thus obtained is the measurement result A of the embodiment of the present invention.

Measurement result B of the conventional technique is a measurement result where a third voltage V3, which is a deposition start voltage, and a fourth voltage V4, which is a transmission returning voltage, were used without using a transmittance holding pulse P. A conventional drive circuit continued a state of 0V for five seconds and applied the third voltage V3 that is a deposition start voltage of 2.4V to the electrodeposition element 2 at the time of five seconds, which is the time of the start of light reduction. A measurement result thus obtained is the measurement result B of the conventional technique.

It can be seen from FIG. 5 that the duration of decrease of the transmittance from 77% to 9% is approximately 24 seconds in the measurement result A of the embodiment of the present invention and is approximately 55 seconds in the measurement result B of the conventional technique.

It can be seen from FIG. 5 that in the embodiment of the present invention, the speed of reaction when the metal ions start deposition on the electrode in a predetermined transmission state is high relative to the conventional technique. In other words, by applying the full-transmission pulse P1 in advance in the full-transmission state before the transmittance being lowered, to vibrate metal ions for easy movement of the metal ions, movement of the metal ions when application of the third voltage V3 is started is facilitated and thus a speed of lowering of the transmittance is increased.

### [Image Pickup Device]

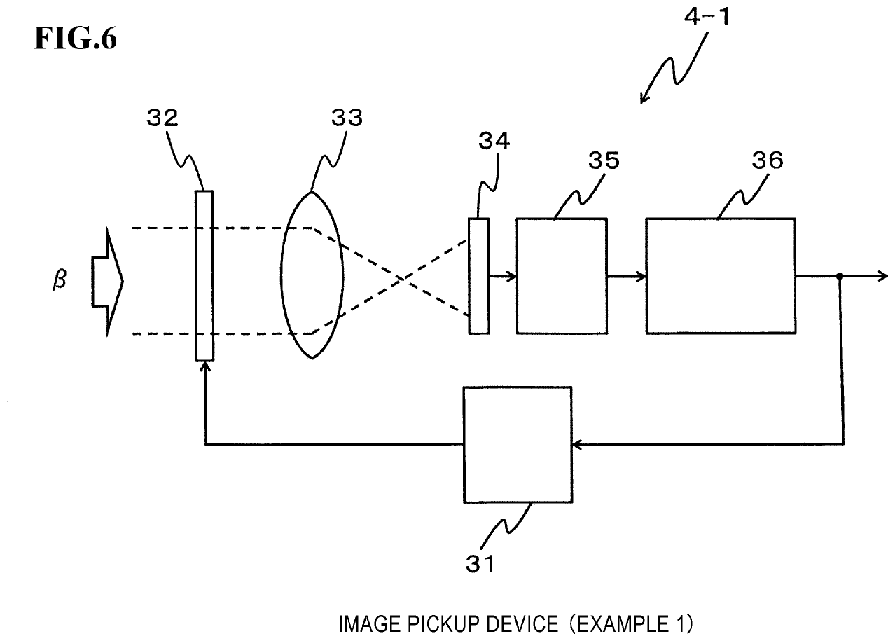

Next, a case where the drive circuit 1 and the electrodeposition element 2 illustrated in FIG. 1 are used in an image pickup device will be described. FIG. 6 is a schematic diagram illustrating an example overall configuration of an image pickup device according to Example 1. An image pickup device 4-1 includes a filter drive circuit 31, a light reduction filter 32, a lens 33, an image pickup element 34, an analog signal processing section 35 and a digital signal processing section 36.

The filter drive circuit 31 is a circuit corresponding to the drive circuit 1 illustrated in FIG. 1 and in order to correct an amount of incident light β entering the image pickup element 34, applies a predetermined voltage to the light reduction filter 32 to drive the light reduction filter 32.

The filter drive circuit 31 receives an input of an image signal output from the image pickup device 4-1, and based on luminance information of the image signal, generates a selection signal indicating any of “transmittance holding”, “light reduction” and “transmission”. Then, if the selection signal indicates “transmittance holding”, the filter drive circuit 31 generates a pattern of a transmittance holding pulse P, and if the selection signal indicates “light reduction”, generates a third voltage V3, which is a deposition start voltage. Also, if the selection signal indicates “transmission”, the filter drive circuit 31 generates a fourth voltage V4, which is a transmission returning voltage.

The filter drive circuit 31 continuously outputs the generated pattern of the transmittance holding pulse P, the generated third voltage V3, which is a deposition start voltage, or the generated fourth voltage V4, which is a transmission returning voltage, to the light reduction filter 32.

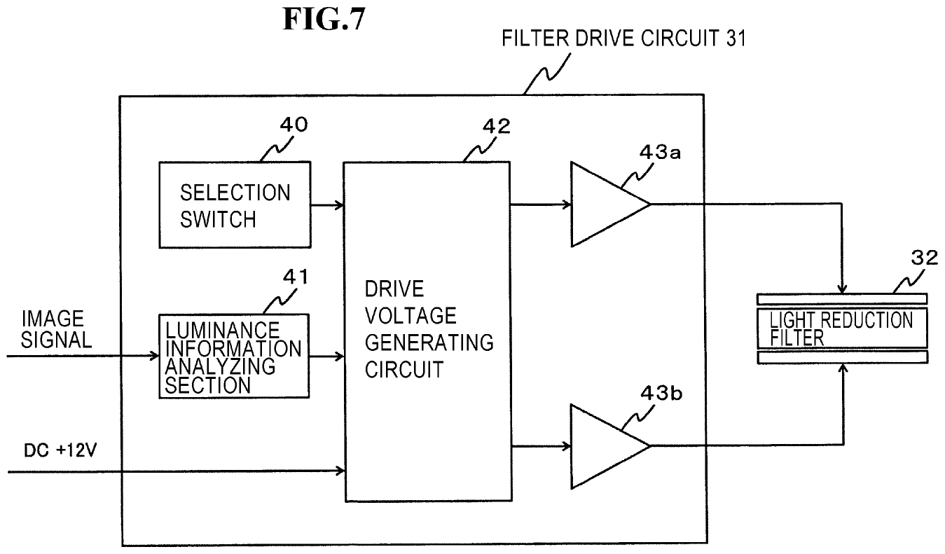

FIG. 7 is a block diagram illustrating an example configuration of the filter drive circuit 31. The filter drive circuit 31 includes a selection switch 40, a luminance information analyzing section 41, a drive voltage generating circuit 42 and buffer amplifiers 43a, 43b. The filter drive circuit 31 is supplied with a direct-current (DC) voltage of +12V.

The selection switch 40 outputs a selection signal indicating any of “transmittance holding”, “light reduction”, “transmission” and “auto” (automatic operation) to the drive voltage generating circuit 42. The selection signal indicating any of “transmittance holding”, “light reduction”, “transmission” and “auto” is set by a user.

The luminance information analyzing section 41 receives an input of an image signal output from the image pickup device 4-1. Then, the luminance information analyzing section 41 analyzes the luminance information of the image signal and, by means of threshold value processing based on the luminance information, generates an automatic selection signal for any of “transmittance holding”, “light reduction” and “transmission” so as to if the image is dark, make the image bright and if the image is bright, make the image dark. Then, the luminance information analyzing section 41 outputs the automatic selection signal to the drive voltage generating circuit 42. This automatic selection signal is a signal used by the drive voltage generating circuit 42 if the selection signal output from the selection switch 40 indicates “auto”.

The drive voltage generating circuit 42, which corresponds to the drive circuit 1 illustrated in FIG. 1, receives an input of the selection signal from the selection switch 40 and also receive an input of the automatic selection signal from the luminance information analyzing section 41. Also, the drive voltage generating circuit 42 receives an input of the direct-current voltage of +12V.

If the selection signal input from the selection switch 40 indicates any of “transmittance holding”, “light reduction” and “transmission”, the drive voltage generating circuit 42 ignores the automatic selection signal input from the luminance information analyzing section 41. Then, if the selection signal indicates “transmittance holding”, as with the processing in the transmittance holding pulse generating section 20 illustrated in FIG. 4, the drive voltage generating circuit 42 generates a pattern of a transmittance holding pulse P and continuously outputs a voltage of the pattern of the transmittance holding pulse P to the light reduction filter 32 via the buffer amplifiers 43a, 43b.

On the other hand, if the selection signal indicates “light reduction”, as with the processing in the deposition start voltage generating section 21 illustrated in FIG. 4, the drive voltage generating circuit 42 generates a third voltage V3, which is a deposition start voltage, and outputs the third voltage V3 to the light reduction filter 32 via the buffer amplifiers 43a, 43b.

Also, if the selection signal indicates “transmission”, as with the processing in the transmission returning voltage generating section 22 illustrated in FIG. 4, the drive voltage generating circuit 42 generates a fourth voltage V4, which is a transmission returning voltage, and outputs the fourth voltage V4 to the light reduction filter 32 via the buffer amplifiers 43a, 43b.

If the selection signal input from the selection switch 40 indicates “auto”, the drive voltage generating circuit 42 outputs a predetermined voltage to the light reduction filter 32 via the buffer amplifiers 43a, 43b according to the automatic selection signal input from the luminance information analyzing section 41.

More specifically, if the selection signal indicates “auto” and the automatic selection signal indicates “transmittance holding”, as with the processing in the transmittance holding pulse generating section 20 illustrated in FIG. 4, the drive voltage generating circuit 42 reads out various data of a frequency f, etc., corresponding to the current transmittance from the memory, generates a pattern of a transmittance holding pulse P and continuously output a voltage of the pattern of the transmittance holding pulse P.

On the other hand, if the selection signal indicates “auto” and the automatic selection signal indicates “light reduction”, as with the processing in the deposition start voltage generating section 21 illustrated in FIG. 4, the drive voltage generating circuit 42 generates a third voltage V3, which is a deposition start voltage, and outputs the third voltage V3.

Also, if the selection signal indicates “auto” and the automatic selection signal indicates “transmission”, as with the processing in the transmission returning voltage generating section 22 illustrated in FIG. 4, the drive voltage generating circuit 42 generates a fourth voltage V4, which is a transmission returning voltage, and outputs the fourth voltage V4.

The buffer amplifiers 43a, 43b perform impedance separation between the drive voltage generating circuit 42 and the light reduction filter 32.

Referring back to FIG. 6, the light reduction filter 32, which corresponds to the electrodeposition element 2 illustrated in FIG. 1, is a filter for correcting an amount of incident light β entering the image pickup element 34. In this case, the substrate 11 provided in the light reduction filter 32 (see FIG. 1) is transparent, which is the same as the transparent substrate 10. The light reduction filter 32 receives an input of a predetermined voltage from the filter drive circuit 31 and changes the transmission state of the light control layer 14 to the full-transmission state or a light-reduced state according to the voltage.

Consequently, if the transmission state of the light control layer 14 is the full-transmission state, light transmitted by the light reduction filter 32 enters the image pickup element 34 via the lens 33 for shooting, with an amount of the light unchanged because of the amount of incident light β being not corrected. On the other hand, if the transmission state of the light control layer 14 is a light-reduced state, light transmitted by the light reduction filter 32 enters the image pickup element 34 via the lens 33 with the amount of incident light β corrected.

The image pickup element 34 converts light entered via the light reduction filter 32 and the lens 33 into an analog electric signal and outputs the analog signal to the analog signal processing section 35.

The analog signal processing section 35 receives an input of the analog signal from the image pickup element 34 and performs analog signal processing such as amplification and A/D conversion of the analog signal. Then, the analog signal processing section 35 outputs a digital signal resulting from the analog signal processing to the digital signal processing section 36.

The digital signal processing section 36 receives an input of the digital signal from the analog signal processing section 35 and performs digital signal processing such as development processing, color conversion and gamma correction. Then, the digital signal processing section 36 outputs an image signal resulting from the digital signal processing to the filter drive circuit 31 and the outside.

As above, according to the image pickup device 4-1 of Example 1 illustrated in FIG. 6, in order to correct the amount of incident light β entering the image pickup element 34, the filter drive circuit 31 performs processing corresponding to that in the drive circuit 1 illustrated in FIG. 1. More specifically, in a “transmittance holding” period in which the transmission state of the light reduction filter 32 is held to be a predetermined transmission state such as the full-transmission state, the filter drive circuit 31 generates a pattern of a transmittance holding pulse P and outputs the transmittance holding pulse P to the light reduction filter 32.

Then, in a “light reduction” period in which the transmission state of the light reduction filter 32 is held to be a light-reduced state (transmittance is lowered), the filter drive circuit 31 applies a third voltage V3, which is a preset deposition start voltage, to the light reduction filter 32.

Consequently, as in the case of the drive circuit 1, a speed of reaction when metal ions start deposition on an electrode can be increased. In other words, a light reduction speed can be increased, and thus, the time of change from a predetermined transmission state to a light-reduced state with a lower transmittance can be shortened.

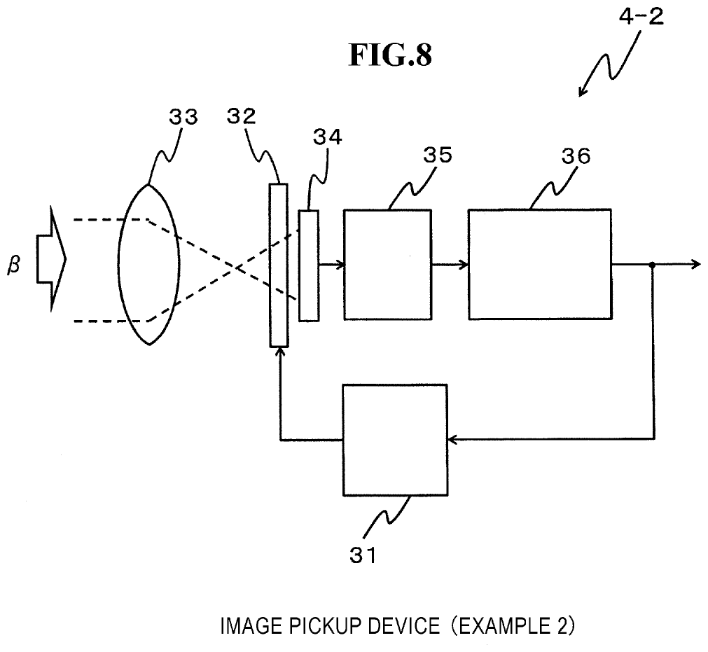

The image pickup device 4-1 according to Example 1 illustrated in FIG. 6 is an example in which the light reduction filter 32 is provided on the front side of the lens 33. However, the light reduction filter 32 may be provided on the rear side of the lens 33. FIG. 8 is a schematic diagram illustrating an example overall configuration of an image pickup device according to Example 2. The image pickup device 4-2 include component sections that are the same as those of the image pickup device 4-1 according to Example 1 illustrated in FIG. 6.

Where the image pickup device 4-1 according to Example 1 illustrated in FIG. 6 and the image pickup device 4-2 are compared with each other, the image pickup device 4-2 is different in including a light reduction filter 32 on the rear side of a lens 33, from the image pickup device 4-1 including the light reduction filter 32 on the front side of the lens 33. The image pickup device 4-2 includes the light reduction filter 32 between the lens 33 and an image pickup element 34. In FIG. 8, parts that are in common with FIG. 6 are provided with reference numerals that are the same as those in FIG. 6 and detailed description thereof will be omitted.

As described above, the image pickup device 4-2 according to Example 2 illustrated in FIG. 8 exerts effects that are similar to those of the image pickup device 4-1 according to Example 1.

Note that although the image pickup device 4-2 includes the light reduction filter 32 and the image pickup element 34 separately, instead of the light reduction filter 32 and the image pickup element 34 that are separate from each other, the image pickup device 4-2 may include an element in which a light reduction filter 32 and an image pickup element 34 are integrated. The integrated element is configured by directly stacking the light reduction filter 32, which corresponds to the electrodeposition element 2 illustrated in FIG. 1, on the image pickup element 34.

Although the present invention has been described above taking an embodiment, the present invention is not limited to the embodiment and various alterations are possible without departing from the technical idea of the invention. The above-described embodiment is configured in such a manner that a state in which metal ions inside the light control layer 14 of the electrodeposition element 2 are vibrated by providing dispersion energy to the metal ions is created using a voltage of a pattern of a transmittance holding pulse P. The present invention does not intend to limit the method for creating such state to a method using a voltage of a pattern of a transmittance holding pulse P, and for example, ultrasound, radiation or heat may be used or the electrodeposition element 2 may be vibrated.

In brief, any method that enables metal ions inside a light control layer to be vibrated by providing dispersion energy to the metal ions may be employed. In this case, the drive circuit 1 includes an energy supply section for providing dispersion energy to metal ions inside the light control layer 14 to vibrate the metal ions, using, e.g., ultrasound, radiation or heat. Even in a period for providing a third voltage V3, which is a deposition start voltage, to the electrodeposition element 2, it is also possible to continue provision of dispersion energy to the metal ions.

### REFERENCE SIGNS LIST

1 drive circuit
2 electrodeposition element
3a, 3b conductive wire
4-1, 4-2 image pickup device
10 transparent substrate
11 substrate
12a, 12b transparent conductive film
13a, 13b sealing material
14 light control layer
20 transmittance holding pulse generating section
21 deposition start voltage generating section
22 transmission returning voltage generating section
31 filter drive circuit
32 light reduction filter
33 lens
34 image pickup element
35 analog signal processing section
36 digital signal processing section
40 selection switch
41 luminance information analyzing section
42 drive voltage generating circuit
43a, 43b buffer amplifier
P transmittance holding pulse
P1 pulse for full transmission
P2 pulse for transmission
Va crystal nucleation voltage
Vb crystal growth voltage
V1 first voltage
V2 second voltage
V3 deposition start voltage (third voltage)
V4 transmission returning voltage (fourth voltage)
f frequency
t/T duty ratio
τ1, τ2, τ2′, τ3 transmittance
T1 to T7 period
t1, t2 time point
α, β incident light

1. A drive circuit for applying a voltage for changing a transmission state of an electrodeposition element, wherein:
the drive circuit is configured to,
when the electrodeposition element is in a predetermined transmission state, provide energy to an ionized material included in the electrodeposition element to vibrate the ionized material, and
when making the electrodeposition element change from the predetermined transmission state into a light-reduced state in which a transmittance is lower than that of the predetermined transmission state, apply a predetermined voltage exceeding a preset crystal nucleation voltage to the electrodeposition element; and
the crystal nucleation voltage is a voltage at which a crystal nucleus of the ionized material is generated on an electrode included in the electrodeposition element.

2. The drive circuit according to claim 1, wherein:
the drive circuit includes a pulse generating section and a deposition start voltage generating section;
the pulse generating section is configured to, when the electrodeposition element is in the predetermined transmission state, generate a pulse voltage as an energy source for providing energy to the ionized material included in the electrodeposition element to vibrate the ionized material, and continuously apply the pulse to the electrodeposition element in a predetermined cycle;
the deposition start voltage generating section is configured to, when making the electrodeposition element change from the predetermined transmission state to the light-reduced state in which the transmittance is lower than that of the predetermined transmission state, generate a predetermined deposition start voltage as a voltage for the ionized material to start deposition and apply the deposition start voltage to the electrodeposition element;
a voltage of the pulse is a voltage that, with reference to a preset crystal growth voltage at which the crystal nucleus of the ionized material generated on the electrode included in the electrodeposition element grows, changes so as to exceed or fall below the crystal growth voltage; and
the deposition start voltage is a voltage exceeding the preset crystal nucleation voltage at which the crystal nucleus of the ionized material is generated on the electrode included in the electrodeposition element.

3. The drive circuit according to claim 2, wherein:
a predetermined voltage that is not larger than the crystal nucleation voltage but is not smaller than the crystal growth voltage is defined as a first voltage and a predetermined voltage that is smaller than the crystal growth voltage is defined as a second voltage; and
the pulse generating section is configured to, based on a preset frequency, the first voltage, the second voltage and duty ratios of the first voltage and the second voltage, generate a pattern of the pulse having a cycle corresponding to the frequency and continuously apply the pattern of the pulse to the electrodeposition element.

4. The drive circuit according to claim 3, wherein the pulse generating section is configured to, when continuously applying the pattern of the pulse including the second voltage, open or short-circuit a circuit that applies a voltage from the drive circuit to the electrodeposition element, instead of applying the second voltage, during a period in which the second voltage should be applied.

5. The drive circuit according to claim 1, wherein the predetermined transmission state is a full-transmission state.

6. The drive circuit according to claim 3, wherein:
the pulse generating section is configured to, when the electrodeposition element is in the full-transmission state, generate the pattern of the pulse as a pattern of a pulse for full transmission and continuously apply the pattern of the pulse for full transmission to the electrodeposition element;
the deposition start voltage generating section is configured to, when making the electrodeposition element change from the full-transmission state to the light-reduced state, apply the deposition start voltage to the electrodeposition element;
the pulse generating section is configured to, when the electrodeposition element is in a transmission state corresponding to the light-reduced state resulting from change of state caused by the application of the deposition start voltage by the deposition start voltage generating section, generate a pattern of a pulse for transmission, the pattern being different from the pattern of the pulse for full transmission, and continuously apply the pattern of the pulse for transmission to the electrodeposition element;
the pattern of the pulse for full transmission is a pattern that brings the electrodeposition element into the full-transmission state; and
the pattern of the pulse for transmission is a pattern that causes the electrodeposition element to be held in a transmission state in which the transmittance is lower than that of the full-transmission state.

7. The drive circuit according to claim 3, wherein:
the drive circuit further includes a transmission returning voltage generating section;
the transmission returning voltage generating section is configured to, when making the electrodeposition element change from the light-reduced state to a full-transmission state, generate a preset transmission returning voltage that causes the crystal nucleus of the ionized material to be dissolved and apply the transmission returning voltage to the electrodeposition element;
the pulse generating section is configured to, when the electrodeposition element is in the full-transmission state, generate the pattern of the pulse as a pattern of a pulse for full transmission and continuously apply the pattern of the pulse for full transmission to the electrodeposition element;
the deposition start voltage generating section is configured to, when making the electrodeposition element change from the full-transmission state to the light-reduced state, apply the deposition start voltage to the electrodeposition element;
the transmission returning voltage generating section is configured to, when the electrodeposition element is in the light-reduced state resulting from change of state caused by the application of the deposition start voltage by the deposition start voltage generating section, apply the transmission returning voltage to the electrodeposition element;
the pulse generating section is configured to, when the electrodeposition element is in a transmission state during a course of change into the full-transmission state due to the application of the transmission returning voltage by the transmission returning voltage generating section, generate a pattern of a pulse for transmission, the pattern being different from the pattern of the pulse for full transmission, and continuously apply the pattern of the pulse for transmission to the electrodeposition element;
the pattern of the pulse for full transmission is a pattern that brings the electrodeposition element into the full-transmission state; and
the pattern of the pulse for transmission is a pattern that causes the electrodeposition element to be held in the transmission state during the course.

8. A drive method for applying a voltage for changing a transmission state of an electrodeposition element, the drive method comprising:
when the electrodeposition element is in a predetermined transmission state, providing energy to an ionized material included in the electrodeposition element to vibrate the ionized material; and
when making the electrodeposition element change from the predetermined transmission state into a light-reduced state in which a transmittance is lower than that of the predetermined transmission state, applying a predetermined voltage exceeding a preset crystal nucleation voltage to the electrodeposition element,
wherein the crystal nucleation voltage is a voltage at which a crystal nucleus of the ionized material is generated on an electrode included in the electrodeposition element.

9. The drive method according to claim 8, wherein:
the drive method includes
when the electrodeposition element is in the predetermined transmission state, generating a pulse voltage as an energy source for providing energy to the ionized material included in the electrodeposition element to vibrate the ionized material, and continuously applying the pulse to the electrodeposition element in a predetermined cycle, and
when making the electrodeposition element change from the predetermined transmission state to the light-reduced state in which the transmittance is lower than that of the predetermined transmission state, generating a predetermined deposition start voltage as a voltage for the ionized material to start deposition and applying the deposition start voltage to the electrodeposition element;
a voltage of the pulse is a voltage that, with reference to a preset crystal growth voltage at which the crystal nucleus of the ionized material generated on the electrode included in the electrodeposition element grows, changes so as to exceed or fall below the crystal growth voltage; and
the deposition start voltage is a voltage exceeding the preset crystal nucleation voltage at which the crystal nucleus of the ionized material is generated on the electrode included in the electrodeposition element.

10. The drive method according to claim 9, wherein:
a predetermined voltage that is not larger than the crystal nucleation voltage but is not smaller than the crystal growth voltage is defined as a first voltage and a predetermined voltage that is smaller than the crystal growth voltage is defined as a second voltage; and
the method includes, based on a preset frequency, the first voltage, the second voltage and duty ratios of the first voltage and the second voltage, generating a pattern of the pulse having a cycle corresponding to the frequency and continuously applying the pattern of the pulse to the electrodeposition element.

11. The drive method according to claim 8, wherein the predetermined transmission state is a full-transmission state.

12. The drive method according to claim 10, wherein:
the drive method includes
when the electrodeposition element is in the full-transmission state, generating the pattern of the pulse as a pattern of a pulse for full transmission and continuously applying the pattern of the pulse for full transmission to the electrodeposition element,
when making the electrodeposition element change from the full-transmission state to the light-reduced state, applying the deposition start voltage to the electrodeposition element, and
when the electrodeposition element is in a transmission state corresponding to the light-reduced state resulting from change of state caused by the application of the deposition start voltage, generating a pattern of a pulse for transmission, the pattern being different from the pattern of the pulse for full transmission and continuously applying the pattern of the pulse for transmission to the electrodeposition element;
the pattern of the pulse for full transmission is a pattern that brings the electrodeposition element into the full-transmission state; and
the pattern of the pulse for transmission is a pattern that causes the electrodeposition element to be held in a transmission state in which the transmittance is lower than that of the full-transmission state.

13. The drive method according to claim 10, wherein:
the method includes
when making the electrodeposition element change from the light-reduced state to a full-transmission state, generating a preset transmission returning voltage that causes the crystal nucleus of the ionized material to be dissolved and applying the transmission returning voltage to the electrodeposition element,
when the electrodeposition element is in the full-transmission state, generating the pattern of the pulse as a pattern of a pulse for full transmission and continuously applying the pattern of the pulse for full transmission to the electrodeposition element,
when making the electrodeposition element change from the full-transmission state to the light-reduced state, applying the deposition start voltage to the electrodeposition element;
when the electrodeposition element is in the light-reduced state resulting from change of state caused by the application of the deposition start voltage, applying the transmission returning voltage to the electrodeposition element, and
when the electrodeposition element is in a transmission state during a course of change into the full-transmission state due to the application of the transmission returning voltage, generating a pattern of a pulse for transmission, the pattern being different from the pattern of the pulse for full transmission, and continuously applying the pattern of the pulse for transmission to the electrodeposition element;
the pattern of the pulse for full transmission is a pattern that brings the electrodeposition element into the full-transmission state; and
the pattern of the pulse for transmission is a pattern that causes the electrodeposition element to be held in the transmission state during the course.

14. A drive circuit for applying a voltage for changing a transmission state of an electrodeposition element,
wherein the drive circuit is a circuit configured to, when the electrodeposition element is in a full-transmission state, apply a vibrating voltage of a magnitude that causes no change in transmittance of the electrodeposition element to between opposed electrodes of the electrodeposition element, prior to applying a voltage for lowering the transmittance of the electrodeposition element, and subsequently apply a voltage that causes the transmittance to be lowered.

15. A drive method for applying a voltage for changing a transmission state of an electrodeposition element,
the drive method comprising, when the electrodeposition element is in a full-transmission state, applying a vibrating voltage of a magnitude that causes no change in transmittance of the electrodeposition element to between opposed electrodes of the electrodeposition element, prior to applying a voltage for lowering the transmittance of the electrodeposition element, and subsequently applying a voltage that causes the transmittance to be lowered.
